(19) United States
(12) Patent Application Publication
(10) Pub. No.: US 2011/0317847 A1
(43) Pub. Date: Dec. 29, 2011

(54) Rearview Vehicle Mirror

(76) Inventor: Chou Wan Chen, Dongguan (CN)

(21) Appl. No.: 12/897,246

(22) Filed: Oct. 4, 2010

(30) Foreign Application Priority Data
Jun. 25, 2010 (CN) 201020240144.1

(51) Int. Cl. H04B 1/00; B60R 1/12

(52) U.S. Cl. 381/86; 359/871

(57) ABSTRACT

This invention discloses a rearview vehicle mirror, including: a rearview mirror body; and a center speaker device for providing center channel sound and mounted on the rearview mirror body; wherein the center speaker device is provided with at least one speaker above the rearview mirror body. The rearview vehicle mirror has multiple functions and can provide surround stereo sound while providing nice appearance and occupying small space.

### FIELD OF THE INVENTION

The present invention relates to a rearview mirror, and in particular to a rearview vehicle mirror.

### BACKGROUND OF THE INVENTION

The known rearview vehicle mirror normally includes a bracket, a cover and a mirror. The cover is connected to the bracket, and the mirror is mounted on the cover. The rearview vehicle mirror is mounted obliquely on the windscreen in the front of the car. The driver can observe the object behind the car. However, the known rearview vehicle mirror is used for single purpose.

Furthermore, the audio system in the car normally includes a left front speaker, a right front speaker, a left back speaker, a right back speaker, a center speaker and an audio player. The center speaker is mounted on the car console. Thus, it imitates the effect of the sound field in the theater. However, the center speaker occupies a large space in the car console and may lock the sight of the driver, and furthermore it has poor sound effect and ugly appearance.

### SUMMARY OF THE INVENTION

Having the shortcomings as mentioned above, it is an object of the present invention to provide a rearview vehicle mirror which have multiple functions and can provide surround stereo sound while providing nice appearance and occupying small space.

To achieve the above object, the present invention provides a rearview vehicle mirror, comprising: a rearview mirror body; and a center speaker device for providing center channel sound and mounted on the rearview mirror body; wherein the center speaker device is provided with at least one speaker above the rearview mirror body.

Preferably, the center speaker device has a connection mechanism and at least one speaker fixed on the connection mechanism, the connection mechanism is fixed on the rearview mirror body, and the at least one speaker is electrically connected to a car audio player.

Preferably, an electronic clock is mounted on the connection mechanism and above the rearview mirror body.

Preferably, the at least one speaker comprises a low frequency speaker, a high-mid frequency speaker, a high frequency speaker and a mid-frequency speaker; the low frequency speaker and the high-mid frequency speaker are located above one end of the rearview mirror body, and the high frequency speaker and the mid-frequency speaker are located above the other end of the rearview mirror body.

Preferably, the at least one speaker comprises a low frequency speaker, a high-mid frequency speaker, a high frequency speaker and a mid-frequency speaker which are arranged in sequence right above the rearview mirror body.

Preferably, the connection mechanism comprises a first connection element, a second connection element and an active lock assembly; the first connection element is provided with a space for receiving the rear mirror body, and a plurality of mounting holes above the space for mounting the at least one speaker; the second connection element is mounted on a upper portion of the first connection element; the active lock assembly is mounted on the second connection element to releasably lock the rearview mirror body.

Preferably, the first connection element has both ends provided with a lock hook, the rearview mirror body is mounted on the lock hook.

Preferably, a protective mesh is fixed on the first connection element to cover on the at least one speaker.

Preferably, the second connection element is provided with at least one containing groove corresponding to the active lock assembly; the active lock assembly is provided with a movable hook, a spring and a cover plate, the movable hook extends to the front of the rearview mirror body; the spring is received in the containing groove, and both ends of the spring lean against a sidewall of the containing groove and an upper end of the movable hook; the cover plate is fixed on the second connection element and covers on the containing groove.

Preferably, a post for mounting the spring is provided in the containing groove.

Preferably, the movable hook comprises an extending arm, a protrusion and two buckle portions; the protrusion is protruded from the top of the extending arm, the buckle portions are respectively extended from both sides of the top of the extending arm; the top of the extending arm, the protrusion and two buckle portions are all received in the containing groove; the extending arm has a lower end extending to the front of the rearview mirror body; the spring has a lower end sleeved on the protrusion; the buckle portions are buckled with a sidewall of the containing groove.

In the present invention, by mounting a center speaker device for providing center channel sound on the rearview mirror body to cooperate with the speakers at different positions in the car, the rearview vehicle mirror can provide surround stereo sound while providing nice appearance and occupying small space.

### BRIEF DESCRIPTION OF THE DRAWINGS

FIG. 1 is a schematic structural view of a rearview vehicle mirror according to a first embodiment of the present invention;

FIG. 2 is another schematic structural view of the rearview vehicle mirror;

FIG. 3 is a schematic structural view of the rearview vehicle mirror with the cover plate being removed;

FIG. 4 is an exploded view of a connection mechanism according of the present invention;

FIG. 5 is a schematic structural view of a rearview vehicle mirror according to a second embodiment.

### DETAILED DESCRIPTION OF THE PREFERRED EMBODIMENT

Many aspects of the invention can be better understood in the following embodiments with reference to the accompanying drawings.

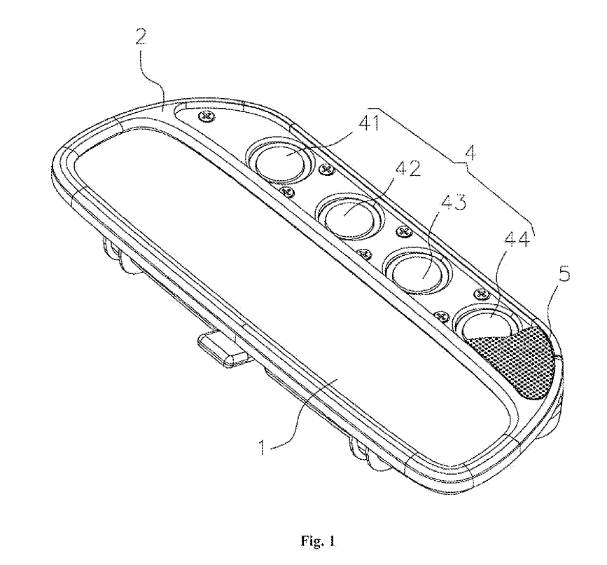

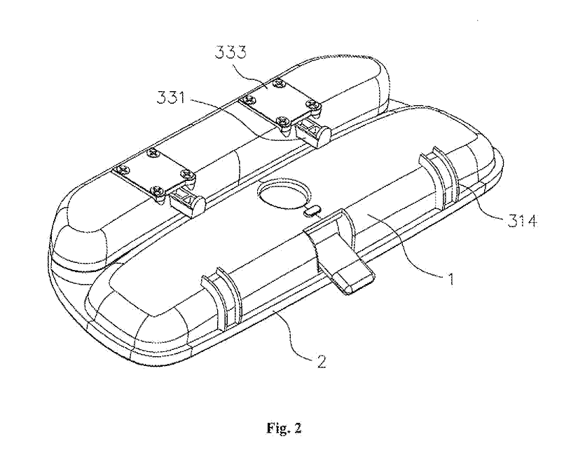

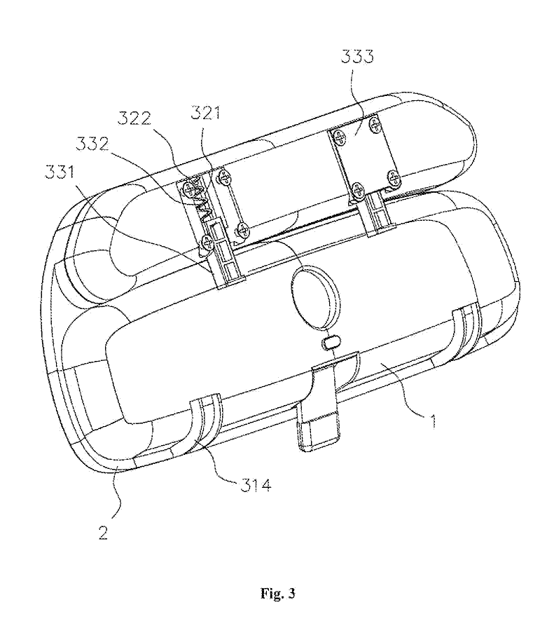

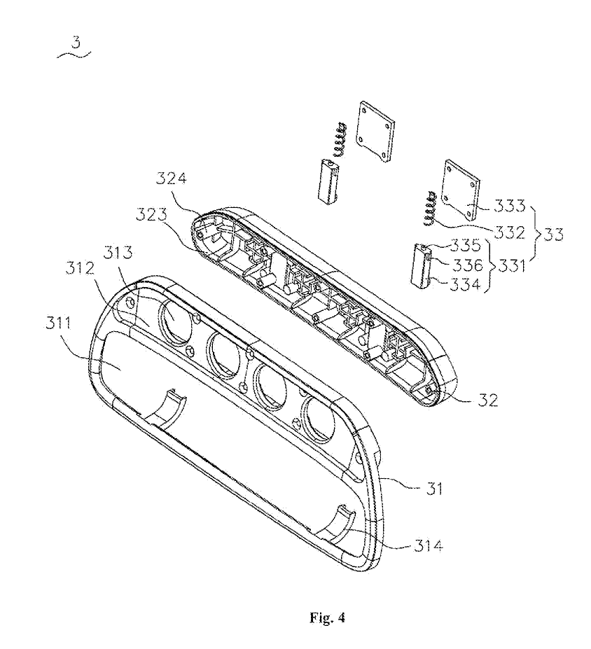

Referring to FIGS. 1 to 4, the rearview vehicle mirror includes a rearview mirror body 1 and a rearview mirror body 1 and a center speaker device 2. The rearview mirror body 1 is mounted on the windscreen in the front of the car. The driver can observe the object behind the car.

The center speaker device 2 is used for providing center channel sound, and is provided with a connection mechanism 3 and several speakers 4 mounted on the connection mechanism 3. The connection mechanism 3 includes a first connection element 31, a second connection element 32 and an active lock assembly 33. The first connection element 31 is provided with a space 311 for receiving the rear mirror body, a recess 312 and a plurality of mounting holes 313. The space 311 extends between the front surface and the back surface of the first connection element 31. The recess 312 is located above the space 311. Several holes 313 are provided in the recess 312.

The speakers 4 electrically connected to the car audio player are respectively inserted in the holes 313. The speakers 4 comprise in sequence a low frequency speaker 41, a high-mid frequency speaker 42, a high frequency speaker 43 and a mid-frequency speaker 44. A protective mesh 5 is fixed on the first connection element 31 and received in the recess 312 to cover on the at least one speaker 4. The first connection element 31 has both ends provided with a lock hook 314 in arc shape extending upwards. The rearview mirror body 1 is mounted on the lock hook 314, and the rearview mirror body 1 is received in the space 311.

The second connection element 32 is in front of the first connection element 31. The second connection element 32 is provided with two containing grooves 321 which extend downwards to the bottom of the second connection element 32. A post 322 for mounting the spring 332 is provided in the containing groove 324.

A matching groove 323 is extended along the periphery of the second connection element 32. Several fixing posts 324 are provided in the second connection element 32 to enable the first connection element 31 to be fixed thereon.

The active block assemblies 33 are corresponding to the containing grooves 321. The active lock assembly 33 is provided with a movable hook 331, a spring 332 and a cover plate 333. The movable hook 331 comprises an extending arm 334, a protrusion 335 and two buckle portions 336. The protrusion 335 is protruded from the top of the extending arm 334. The buckle portions 334 are respectively extended from both sides of the top of the extending arm 334. The top of the extending arm 334, the protrusion 335 and two buckle portions 336 are all received in the containing groove 324. The extending arm 334 has a lower end extending to the front of the rearview mirror body 1. The buckle portion 336 is buckled with the sidewall of the containing groove 321. The lower end of the movable hook 331 is extended to the front of the mirror body 1.

The spring 332 is contained in the containing groove 321, and has a lower end sleeved on the protrusion 335 and a top end sleeved on the post 322. Both ends of the spring 332 respectively lean against a sidewall of the containing groove 321 and an upper end of the movable hook 331. The cover plate 333 is fixed on the second connection element 32 and covers on the containing groove 321. Therefore, the active block assemblies 33 are mounted on the second connection element 32 to releasably lock the rearview mirror body 1.

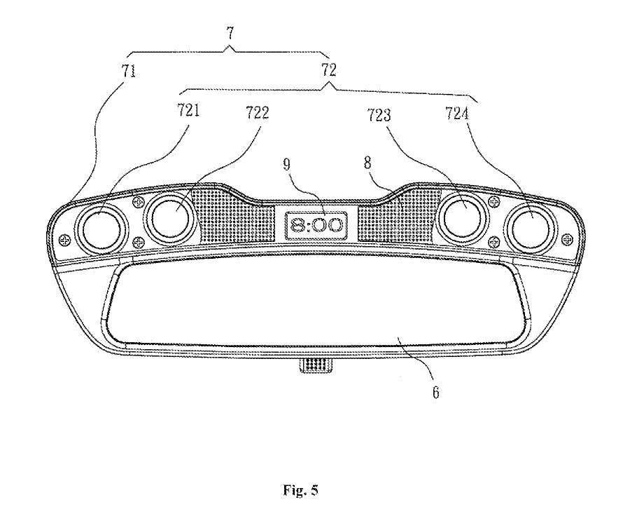

Referring to FIG. 5, a second embodiment of the rearview vehicle mirror is shown. The structure of this embodiment is similar to that of the first embodiment. The rearview vehicle mirror includes a rearview mirror body 6 and a center speaker device 7. The center speaker device 7 has a connection mechanism 71 and several speakers 72 fixed on the connection mechanism 71, and the connection mechanism 71 is fixed on the rearview mirror body 6. The speakers 72 include a low frequency speaker 721, a high-mid frequency speaker 722, a high frequency speaker 723 and a mid-frequency speaker 724. A protective mesh 8 is fixed on the first connection element 71 to cover on the speakers 72. An electronic clock 9 is mounted on the connection mechanism 71 and above the rearview mirror body 6. The low frequency speaker 721 and the high-mid frequency speaker 722 are located above one end of the rearview mirror body 6, and the high frequency speaker 723 and the mid-frequency speaker 724 are located above the other end of the rearview mirror body 6. With the electronic clock 9, it is convenient for the driver to watch the time.

In the present invention, by mounting a center speaker device 2, 7 for providing center channel sound on the rearview mirror body 1, 6 to cooperate with the speakers at different positions in the car, the rearview vehicle mirror can provide surround stereo sound while providing nice appearance and occupying small space.

It should be emphasized that the above-described embodiments can be combined freely. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A rearview vehicle mirror, comprising:
a rearview mirror body; and
a center speaker device for providing center channel sound and mounted on the rearview mirror body;
wherein the center speaker device is provided with at least one speaker above the rearview mirror body.

2. The rearview vehicle mirror of claim 1, wherein the center speaker device has a connection mechanism and at least one speaker fixed on the connection mechanism, the connection mechanism is fixed on the rearview mirror body, and the at least one speaker is electrically connected to a car audio player.

3. The rearview vehicle mirror of claim 2, wherein an electronic clock is mounted on the connection mechanism and above the rearview mirror body.

4. The rearview vehicle mirror of claim 1, wherein the at least one speaker comprises a low frequency speaker, a high-mid frequency speaker, a high frequency speaker and a mid-frequency speaker; the low frequency speaker and the high-mid frequency speaker are located above one end of the rearview mirror body, and the high frequency speaker and the mid-frequency speaker are located above the other end of the rearview mirror body.

5. The rearview vehicle mirror of claim 1, wherein the at least one speaker comprises a low frequency speaker, a high-mid frequency speaker, a high frequency speaker and a mid-frequency speaker which are arranged in sequence right above the rearview mirror body.

6. The rearview vehicle mirror of claim 5, wherein the connection mechanism comprises a first connection element, a second connection element and an active lock assembly; the first connection element is provided with a space for receiving the rear mirror body, and a plurality of mounting holes above the space for mounting the at least one speaker; the second connection element is mounted on a upper portion of the first connection element; the active lock assembly is mounted on the second connection element to releasably lock the rearview mirror body.

7. The rearview vehicle mirror of claim 6, wherein the first connection element has both ends provided with a lock hook, the rearview mirror body is mounted on the lock hook.

8. The rearview vehicle mirror of claim 7, wherein a protective mesh is fixed on the first connection element to cover on the at least one speaker.

9. The rearview vehicle mirror of claim 8, wherein the second connection element is provided with at least one containing groove corresponding to the active lock assembly; the active lock assembly is provided with a movable hook, a spring and a cover plate, the movable hook extends to the front of the rearview mirror body; the spring is received in the containing groove, and both ends of the spring lean against a sidewall of the containing groove and an upper end of the movable hook; the cover plate is fixed on the second connection element and covers on the containing groove.

10. The rearview vehicle mirror of claim 9, wherein a post for mounting the spring is provided in the containing groove.

11. The rearview vehicle mirror of claim 10, wherein the movable hook comprises an extending arm, a protrusion and two buckle portions; the protrusion is protruded from the top of the extending arm, the buckle portions are respectively extended from both sides of the top of the extending arm; the top of the extending arm, the protrusion and two buckle portions are all received in the containing groove; the extending arm has a lower end extending to the front of the rearview mirror body; the spring has a lower end sleeved on the protrusion; the buckle portions are buckled with a sidewall of the containing groove.
